(19) United States
(12) Patent Application Publication
(10) Pub. No.: US 2020/0079619 A1
(43) Pub. Date: Mar. 12, 2020

(54) CONTROL DEVICE FOR AN ELEVATOR SYSTEM, LIFT SYSTEM AND METHOD FOR CONTROLLING AN ELEVATOR SYSTEM

(71) Applicants: thyssenkrupp Elevator AG, Essen (DE); thyssenkrupp AG, Essen (DE)

(72) Inventors: Richard THUM, Kornwestheim (DE); Marius MATZ, Filderstadt (DE); Eduard STEINHAUER, Nürtingen (DE)

(73) Assignees: thyssenkrupp Elevator AG, Essen (DE); thyssenkrupp AG, Essen (DE)

(21) Appl. No.: 16/610,375

(22) PCT Filed: May 3, 2018
(86) PCT No.: PCT/EP2018/061242

§ 371 Date: Nov. 1, 2019

(30) Foreign Application Priority Data
May 5, 2017 (DE) 10 2017 109 727.9

(51) Int. Cl. B66B 1/34; B66B 1/24

(52) U.S. Cl. CPC B66B 1/3423; B66B 1/2466; B66B 2201/307; B66B 1/3461; B66B 1/2491

(57) ABSTRACT

A control system, installation, and methods for an elevator installation includes at least two elevator cars moveable in at least two shaft segments. The system has at least two shaft control units and at least two elevator car control units. Each of the shaft control units is configured to be respectively assigned to one of the shaft segments and each of the elevator car control units is configured to be respectively assigned to one of the elevator cars. The control system is configured to provide a mutual first communication link between the shaft control units. The control system is configured, for each of the shaft segments, to respectively provide a second communication link between the elevator car control units which are assignable to the elevator cars and the shaft control unit which is assignable to the respective shaft segment.

The present invention relates to a control system for an elevator installation comprising at least two elevator cars, which are moveable in at least two shafts, an elevator installation and a method for controlling an elevator installation.

### PRIOR ART

In addition to elevators, in which an elevator car is moveable in a shaft, elevator installations also exist comprising a plurality of shafts in which, in turn, a plurality of elevator cars are moveable in each case. Additionally, elevator installations exist in which elevator cars are interchangeable back and forth between two adjoining shafts. This can be achieved, for example, by the employment of linear motor drive systems and “exchange units” (also described as “exchangers”), by means of which the elevator car can be conveyed from one shaft to another shaft via an interchange shaft.

However, as the number of elevator cars and shafts increases, a problem arises, in that communication between an elevator control system and the individual elevator cars becomes increasingly difficult. This is not least attributable to communication links with a limited data transmission capacity per unit of time.

In this context, the object of the present invention, even in elevator installations having a large number of elevator cars or shafts, is therefore to permit simple and rapid communication with the individual elevator cars.

### DISCLOSURE OF THE INVENTION

According to the invention, a control system, an elevator installation and a method for controlling an elevator installation are proposed, having the characteristics of the independent patent claims. Advantageous configurations are the subject matter of the sub-claims, and of the following description.

A control system according to the invention is provided for an elevator installation comprising at least two elevator cars, which are moveable in at least two shaft segments, and specifically are individually moveable, i.e. in an essentially mutually independent manner. At least two shaft control units and at least two elevator car control units are provided, wherein each of the shaft control units is designed to be respectively assigned to one of the shaft segments and each of the elevator car control units is designed to be respectively assigned to one of the elevator cars. Moreover, the control system is designed to provide a first mutual communication link between the shaft control units and, for each of the shaft segments, to respectively provide a second communication link between the elevator car control units which are assignable to the elevators cars situated in the respective shaft segment and the shaft control unit which is assignable to the respective shaft segment.

Additionally, in an elevator installation of this type, in which the control system can be employed, specifically at least two shafts can be provided, which respectively comprise at least one shaft segment. An elevator installation of this type can thus comprise a total of only two shaft segments, which are assigned to two shafts. Preferably, however, at least one of the shafts can also comprise two or more shaft segments. It is also conceivable that only shaft might be provided, which comprises two or more shaft segments.

In a control system of this type, a plurality of individual communication links are now provided, which can be employed in a mutually independent manner. It is thus sufficient, for example, if the elevator car control units for the elevator cars situated in one shaft segment can only communicate with one shaft control unit which is assignable to the respective shaft segment. This shaft control unit, in turn, can communicate via a further communication link with the other shaft control units, or optionally with a superordinate central control unit. In this manner, it is further ensured that each of the elevator cars or the assignable elevator car control unit can be actuated or can receive control information, wherein, however, the requisite bandwidth for a respective communication link is significantly reduced, on the grounds that, in total, fewer communication participants are involved in the respective communication link.

Specifically, in this manner, it can also be prevented that unnecessary information is transmitted via a communication link. Thus, for example, in the event of the employment of a total of only one single communication link or a single communication network, each message transmitted will include data which are not required whatsoever by many other communication participants. Such data can be reduced by means of the proposed control system, as a result of which the speed of communication can also be increased.

A further advantage of the proposed control system is the modular structure thereof. It is thus possible, in a very simple manner, to provide a control system for an elevator installation of any size. Specifically, to this end, the individual shaft control units are configured to an identical design. Advantageously, the individual elevator car control units are also configured to an identical design. Further shaft segments and/or elevator cars can thus be added to an existing system in a very simple manner. Moreover, the control system is also scalable in a highly simple manner. Additionally, advantageously, the failure, for example, of one elevator car or one elevator car control unit will not result in a failure of the entire elevator installation or the entire control system, but only a failure of the relevant elevator car or, where applicable, the relevant shaft. Thus, in the event of the failure of one of the shaft control units and/or one of the elevator car control units, operation of the shaft segment which is currently assigned to said shaft control unit and/or said elevator car control unit can be suspended, wherein the remaining shaft segments continue to operate. Advantageously, the elevator installation can thus remain in service, at least in a restricted manner.

Advantageously, the control system is further designed, by means of the second communication links, to respectively provide direct communication between each of the elevator car control units which are assignable to the elevator cars which are situated in the respective shaft segment and the shaft control unit which is assigned to the respective shaft segment. Information can thus be transmitted to an individual elevator car in an exceptionally rapid and simple manner, such as, for example, a target storey, but specifically also safety-related data or parameters, such as travel parameters relating to the current speed and/or acceleration of an elevator car, a setting of an exchange unit, a clearance between one elevator car to the next, or communication of a “stopping point”, i.e. a point which is calculated by an elevator car control unit in an ongoing manner, and defines the latest point at which the elevator car can be brought to a halt).

Advantageously, the control system is further designed, by means of the second communication links, to respectively provide direct communication between the elevator car control units of two respectively adjoining elevator cars which are situated in the respective shaft segment. Two adjoining elevator cars are specifically understood here as two directly sequential elevator cars in the shaft segment. In this manner, for example, information can rapidly be exchanged with respect to the clearance or the speed of the preceding elevator car, in order to permit, for example, the adjustment of speed.

It is advantageous if the control system additionally comprises a central control unit, which is communicatively connected with the shaft control units, or which incorporates the latter. For example, the central control unit can be incorporated in the first communication link, or, however, the shaft control units constitute, for example, modules of the central control unit. As mentioned above, a central control unit of this type permits the control of the entire elevator installation. In this case, however, the modular design with different communication links is now employed.

The elevator installation preferably comprises at least one exchange unit between two adjoining shaft segments, by means of which elevator cars can be interchanged between the two adjoining shaft segments. Where two shaft segments are located in two different shafts, additionally, an interchange shaft can specifically be provided here. To this end, for example, at an interface between one shaft, i.e. specifically a vertical shaft, and an interchange shaft, i.e. specifically a horizontal shaft, an above-mentioned exchange unit (also described as an exchanger) can be provided. Exchangers of this type permit an alteration of a direction of motion of an elevator car, specifically between the vertical, the horizontal and the diagonal. The control system can then be preferably further designed, upon the interchange of an elevator car from one of the shaft segments to another of the shaft segments, to remove the shaft control unit which is assigned to the elevator car from the second communication link in the one shaft segment, and to execute the addition thereof to the second communication link in the other shaft segment. In this manner, moreover, each of the shaft control units continues to be responsible for the elevator cars located in its respective shaft segment or for the associated elevator car control units. An exchange of this type can then be initiated, for example, by a shaft control unit such that thereafter, even immediately thereafter, the correct or the desired communication links are available.

Advantageously, the control system comprises a first communication network, which is designed to provide the first communication link. The first communication network can preferably comprise a wire-based communication network, specifically a bus or an ethernet. Wire-based communication networks of this type are particularly suitable for shaft control units, as they can be configured in a stationary arrangement and, moreover, transmit relatively large volumes of data.

Preferably, the control system comprises at least two second communication networks, each of which is designed to provide one of the second communication links. The second communication networks preferably respectively comprise wireless communication networks, specifically WLANs. Very particularly preferably, “slit-wave mode hollow conductors” or “leaky-wave mode conductors” can be employed for this purpose. Slit-wave mode hollow conductors or leaky-wave mode hollow conductors can be laid along a shaft, firstly for the improvement of signal transmission, and secondly for the prevention of unauthorized access.

It is further preferred if communication networks are configured to a redundant design, i.e., for example, the infrastructure, or elements thereof, are present in duplicate. In this manner, fail safety is improved.

A further object of the invention is an elevator installation having at least two elevator cars, which are moveable in at least two shaft segments, which moreover comprises a control system according to the invention, and specifically also at least one exchange unit between two adjoining shaft segments, by means of which elevator cars can be interchanged between the two adjoining shaft segments. Each of the shaft control units is respectively assigned to one of the shaft segments and each of the elevator car control units is respectively assigned to one of the elevator cars. The elevator installation can additionally comprise at least two shafts, each comprising at least one shaft segment, and specifically two shaft segments respectively, of the type described in greater detail above.

Specifically, it is provided that the elevator installation comprises a linear motor drive system, by means of which the at least two elevator cars can be driven in the at least two shaft segments. According to an advantageous configuration, at least one drive segment of the linear motor drive system is assigned to one shaft segment or shaft section. This at least one drive segment can advantageously be actuated by means of the shaft control unit (or shaft segment control system). Specifically, a plurality of drive segments are assigned to one shaft segment, which can then also preferably be actuated by means of the relevant shaft control unit.

With respect to the advantages and further configurations of the elevator installation according to the invention, in the interests of the avoidance of repetitions, reference shall be made to the explanations of the control system set out above.

A further object of the invention is a method for controlling an elevator installation having at least two elevator cars, which are moveable in at least two shaft segments, having at least two shaft control units, each of which is assigned to one of the shaft segments, and having at least two elevator car control units, each of which is assigned to one of the elevator cars. Mutual communication between the shaft control units is executed by means of a first communication link, and communication between the elevator car control units which are assigned to the elevator cars which are situated in a respective shaft segment and the shaft control unit which is assigned to the respective shaft segment is respectively executed by means of a second communication link. By way of an elevator installation, an elevator installation according to the invention is specifically provided which, in turn, comprises a control system according to the invention.

With respect to the advantages and further configurations of the method according to the invention, in the interests of the avoidance of repetitions, reference shall be made to the explanations of the control system set out above.

Further advantages and configurations of the invention proceed from the description and from the attached drawing.

It is understood that the above-mentioned characteristics, and those described hereinafter, are not only applicable in the respective combination indicated, but also in other combinations or in isolation, without departing from the scope of the present invention.

The invention is schematically represented in the drawing, with reference to an exemplary embodiment, and is described hereinafter with reference to the drawing.

### DESCRIPTION OF FIGURES

FIGS. 1a and 1b show schematic representations of an elevator installation according to the invention, having a control system in a preferred form of embodiment, with the elevator cars in various positions.

FIGS. 2a and 2b show schematic representations of a control system according to the invention in a preferred form of embodiment, with the elevator car control units in various positions.

FIG. 3 shows a schematic representation of a slotted hollow conductor, of the type which can be employed in the context of the present invention.

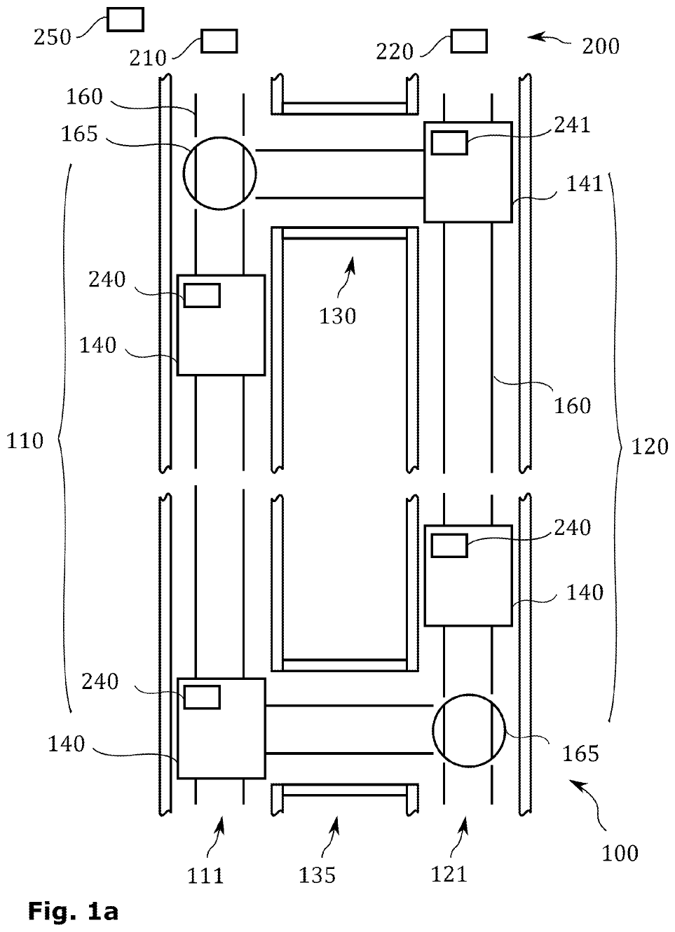

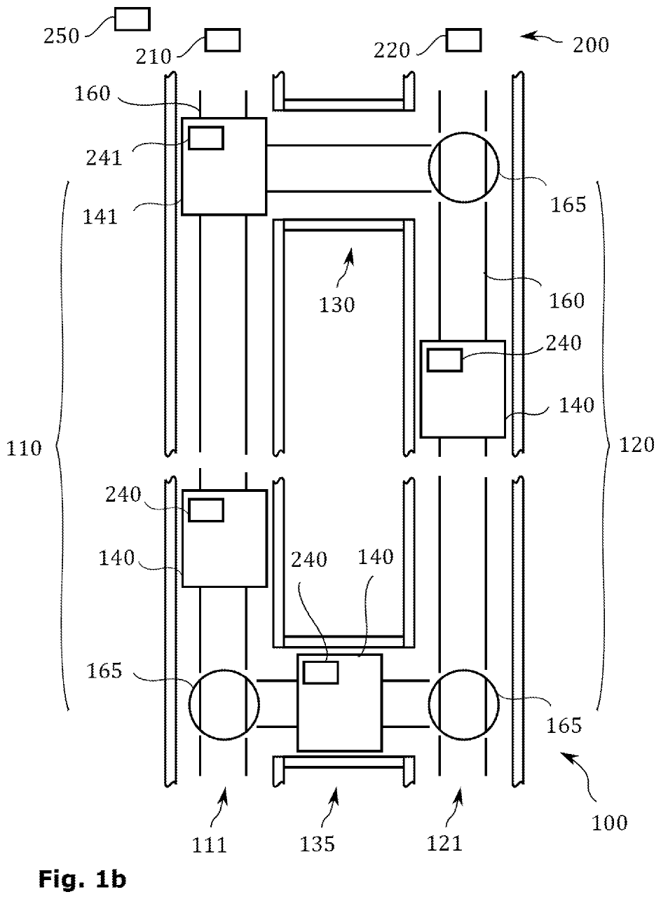

FIG. 1a shows a schematic representation of an elevator installation 100 according to the invention, having a control system 200, in a preferred form of embodiment. In the present case, the elevator installation 100 comprises two shaft segments 110 and 120 in which, in the present case, for example, four elevator cars 140, 141 are moveable. In the example represented, the shaft segments 110 and 120 each comprise part of a respective (vertical) shaft 111 or 121 which, above and/or below, can comprise further shaft segments.

Two interchange shafts 130 and 135 are further represented, which interconnect the two shafts 111 and 121 at various points. The interchange shafts are connected to the shafts by means of exchange units 165. The shaft segments are thus located between two exchange units. These interchange shafts or exchange units can be arranged, for example, on a lowermost and uppermost storey which are served by the elevator installation 100, specifically where the elevator installation executes a “continuous revolving operating mode”. As represented in FIG. 1a, however, exchange units are also specifically arranged between the lowermost storey and the uppermost storey of a building.

In the shaft segments 110 and 120, and in the interchange shafts 130 and 135, rails 160 are respectively provided, along which the elevator cars 140 can be conveyed, for example by means of appropriate guidance devices. At intersection points between the shafts and interchange shafts, exchange units 165, or “exchangers”, are provided. By means of these exchange units 165, in the present exemplary embodiment, the elevator cars 140, 141 can switch between a vertical and a horizontal motion.

Motion of the elevator cars 140, 141 along the rails 160 can be achieved, for example, by means of “linear motor drive systems”. The elevator installation 100 is a “multi-car elevator installation”, which is known, for example, by the name MULTI®. In a multi-car elevator installation of this type, the elevator cars 140, 141 can travel in a loop, in a “continuous revolving operating mode”, i.e. upwards in one shaft and downwards in the other shaft. It is understood that further shafts, with shaft segments, and specifically further elevator cars can also be provided.

A control system 200 is further provided. In the present case, the control system 200 comprises a central control unit 250, two shaft control units 210 and 220, and four elevator car control units 240, 241. The shaft control unit 210 is assigned to shaft segment 110, and the shaft control unit 220 is assigned to shaft segment 120. Each of the elevator car control units 240, 241 is respectively assigned to one of the elevator cars 140, 141. It should be observed that, in the present case, in the interests of clarity, only the respective control units, but not the communication links, are represented.

FIG. 1b shows a further representation of the elevator installation 100 from FIG. 1a, but with the elevator cars 140, 141 and their associated elevator car control units 240, 241 in a different position. A more detailed description is provided hereinafter.

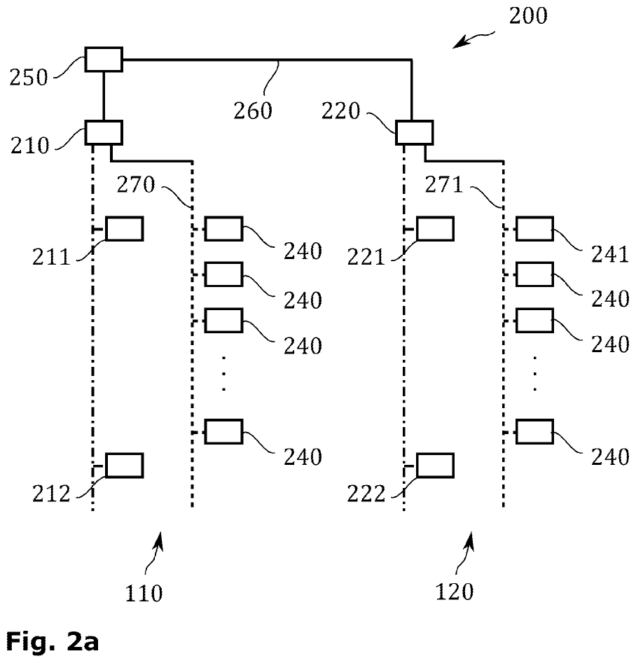

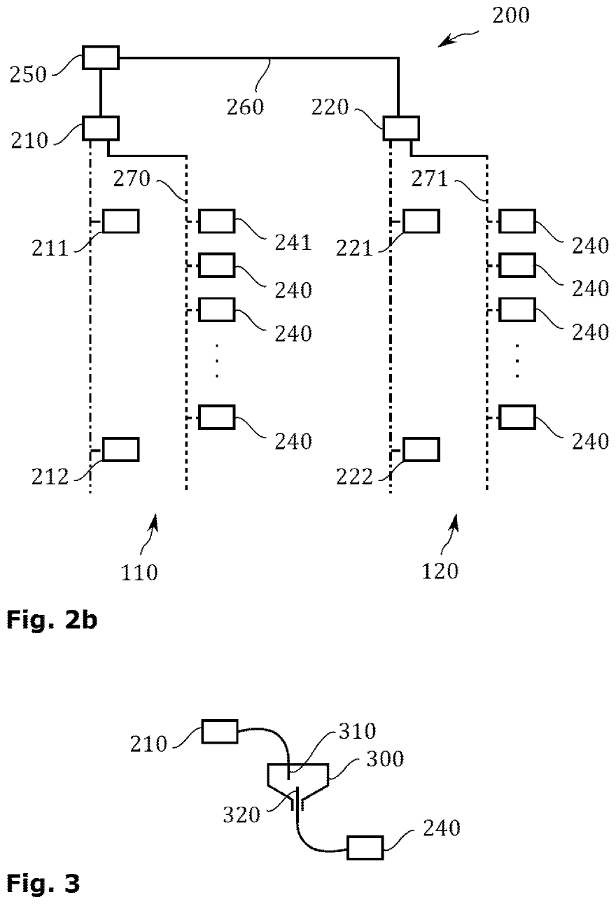

FIG. 2a shows a schematic representation of a control system 200 according to the invention, in a preferred form of embodiment, as previously represented, in an exemplary manner, in FIG. 1a or 1b. The central control unit 250 and the shaft control units 210 and 220 are interconnected by means of a first communication link 260.

As already indicated, the central control unit and the shaft control units can be separate control units; however, the shaft control unit can also be a module of the central control unit 250. The first communication link 260 can comprise, for example, a bus or an ethernet.

Additionally to the shaft control unit 210, two slave control units 211 and 212 are represented, which can be elements of the shaft control unit 210. Likewise, additionally to the shaft control unit 220, two slave control units 221 and 222 are represented. In this manner, for example, a control system of an exchange unit can be more simply integrated in the control system of a shaft segment and, specifically, the slave control units 212 or 222 can be arranged at the lower end of the respective shaft segment, for example in order to execute the control of the respective exchange unit, whereas the slave control units 211 or 221 are responsible for the control of the elevator cars or for communication with the elevator car control units 240.

Elevator car control units 240, 241 are now further represented, as previously indicated in FIGS. 1a and 1b, although more exemplary elevator car control units are represented in this case. Each of these elevator car control units 240, 241 can be configured to an identical design.

Moreover, two second communication links 270 and 271 are represented, which are assigned to the shaft segment 110 or 120. The elevator car control units 240, which are situated in the shaft segment 110, are now integrated in the second communication link 270, and can communicate thereby with the shaft control unit 210. Specifically, it can also be provided that the elevator car control units which are situated in the shaft segment 110 communicate with the slave control unit 211 which is an element of the shaft control unit 210.

Correspondingly, the elevator car control units 240, 241, which are situated in the shaft segment 120, are integrated in the second communication link 271, and can communicate thereby with the shaft control unit 220. Specifically, it can also be provided here that the elevator car control units which are situated in the shaft segment 120 communicate with the slave control unit 221 which is an element of the shaft control unit 220.

Accordingly, the elevator car control units of the elevator cars which are situated in a shaft can only communicate with the shaft control unit which is assigned to the respective shaft segment. As already indicated above, it can further be provided that the elevator car control units of in each case two elevator cars situated in proximity in a shaft segment, i.e. specifically one above another or one below another, are configured for direct mutual communication. Communication between the elevator car control units of elevator cars in different shaft segments is not provided, and is not required.

With reference to FIGS. 1a and 1b, and to FIGS. 2a and 2b, a sequence of a method according to the invention, in a preferred form of embodiment, is described hereinafter. Where an elevator car moves from one shaft segment to another shaft segment, the elevator car control unit assigned to said elevator car is removed from the second communication link in the shaft segment of departure, and is assigned to that of the new shaft segment.

In the example shown in FIG. 1a, the elevator car 141 at the top right, which is situated in shaft segment 120, can be conveyed by means of the interchange shaft 130 or the associated exchange units to the shaft segment 110. In FIG. 1b, this elevator car 141 is already situated in shaft segment 110. The elevator car control unit 241 of the elevator car 141 is thus removed from the second communication link 271, and thus from the shaft control unit 220 according to FIG. 2a, and is assigned to the second communication link 270 or shaft control unit 210. In FIG. 2b, the elevator car control unit 241 is already assigned to the second communication link 270 or shaft control unit 210. In this manner, it can be ensured that exclusively and, additionally, all those elevator car control units which are situated in one shaft communicate with the associated shaft control unit.

The same applies to a switchover from or to shaft segments which, for example, are situated in the same shaft, but above or below the relevant shaft segment. Thus, for example, in shaft 111 according to FIG. 1a or 1b, a further shaft segment can be provided respectively both above and below the shaft segment 110.

In FIG. 1b, it can further be seen that an elevator car is already situated in the interchange shaft 135. The associated elevator car control unit, as soon as the elevator car arrives in shaft segment 120, can then be assigned to the new second communication link.

It should be observed that, in the event of a switchover between shaft segments which are situated, for example, one above another in a shaft, a reassignment of the relevant elevator car control unit to the new second communication link, and thus to the new shaft control unit, can proceed directly upon the crossover of the exchange unit.

Upon the change from one shaft segment to another shaft segment via an interchange shaft, the reassignment of the relevant elevator car control unit to the new second communication link, and thus to the new shaft control unit, can proceed respectively upon arrival in the new shaft segment or upon the crossover of the relevant exchange unit. Depending upon the direction of the switchover, the interchange shaft can then be associated with one shaft segment or the other. However, the assignment of an interchange shaft to a specific shaft segment is also conceivable. It is also conceivable for the interchange shaft to be considered as a standalone shaft segment, which will then be specifically associated with a dedicated shaft control unit.

In this manner, the communications load is reduced, wherein all the requisite communication links are available at all times. The overall computing capacity to be provided can thus be additionally reduced, on the grounds that, for example, fewer data packets are to be transmitted via the communication links.

The second communication links 270 or 271 can respectively comprise a wireless communication network, as indicated here by broken lines. In order to ensure the availability of a wireless communication link of this type in a high shaft, for example, “slotted hollow conductors” can be employed, as described in greater detail hereinafter with reference to FIG. 3.

The second communication links 270 or 271, in certain regions, can further comprise wire-based communication networks, for example in a region between a shaft control unit and the start of the shaft or shaft section, as indicated in FIG. 2 by solid lines.

FIG. 3 now shows a schematic representation of a slotted hollow conductor 300, of the type which can be employed in the context of the present invention, in cross-section. The slotted hollow conductor 300 can extend along the respective shaft.

In the slotted hollow conductor 300, a shaft antenna 310 is provided, which can be connected to a shaft control unit, in this case, for example, the shaft control unit 210. On the elevator car control units 240, 241 (in this case, for exemplary purposes, represented for 240 only), in turn, a respective elevator car antenna 320 is provided which, upon the movement of the elevator car in the shaft, moves along the slotted hollow conductor 300.

As the radio waves generated by the antenna are propagated along the slotted hollow conductor 300 in the interior thereof, rapid and secure communication between the elevator car control units and the respective shaft control unit is possible.

1-15. (canceled)

16. A control system for an elevator installation, comprising:
at least two elevator cars,
at least two shaft segments in which the at least two elevator cars are movable,
at least two shaft control units, and
at least two elevator car control units,
wherein each of the shaft control units is configured to be respectively assigned to one of the shaft segments and each of the elevator car control units is configured to be respectively assigned to one of the elevator cars,
wherein the control system is configured to provide a mutual first communication link between the shaft control units, and
wherein the control system is configured, for each of the shaft segments, to respectively provide a second communication link between the elevator car control units which are to be assigned to the elevator cars situated in the respective shaft segment and the shaft control unit which is to be assigned to the respective shaft segment.

17. The control system of claim 16, which is further configured, via the second communication links, to respectively provide direct communication between each of the elevator car control units which are to be assigned to the elevator cars which are situated in the respective shaft segment and the shaft control unit which is to be assigned to the respective shaft segment.

18. The control system of claim 16, which is further configured, via the second communication links to respectively provide direct communication between the elevator car control units of two respectively adjoining elevator cars which are situated in the respective shaft segment.

19. The control system of preceding claim 16, further comprising a central control unit, which is communicatively connected with the shaft control units, or which incorporates the shaft control units.

20. The control system of claim 16, wherein the elevator installation comprises at least one exchange unit between two adjoining shaft segments, by means of which elevator cars can be interchanged between the two adjoining shaft segments, and
wherein the control system is further configured, upon the interchange of an elevator car from one of the shaft segments to another of the shaft segments, to remove the elevator car control unit which is to be assigned to the elevator car from the second communication link in the one shaft segment, and to execute the addition thereof to the second communication link in the other shaft segment.

21. The control system of claim 16, configured to be employed with an elevator installation having at least two shafts, said shafts each comprising at least one shaft segment.

22. The control system of claim 21, configured to be employed with an elevator installation having at least two shafts, said shafts each comprising at least two shaft segments.

23. The control system of claim 16, comprising a first communication network, which is designed to provide the first communication link, wherein the first communication network specifically comprises a wire-based communication network.

24. The control system of claim 23 wherein the first communication network specifically comprises a bus or an ethernet.

25. The control system of claim 23, comprising at least two second communication networks, each of which is designed to provide one of the second communication links, wherein the second communication networks respectively specifically comprise a wireless communication network.

26. The control system of claim 25 wherein the wireless communication network is a WLAN.

27. The control system of claim 25, comprising slotted hollow conductors.

28. An elevator system comprising at least two elevator cars, which are moveable in at least two shaft segments, and having a control system as claimed in one of the preceding claims, and specifically having at least one exchange unit between two adjoining shaft segments, by means of which elevator cars can be interchanged between the two adjoining shaft segments,
wherein each of the shaft control units is respectively assigned to one of the shaft segments and each of the elevator car control units is respectively assigned to one of the elevator cars.

29. A method for controlling an elevator installation comprising at least two elevator cars, which are moveable in at least two shaft segments, comprising at least two shaft control units, each of which is assigned to one of the shaft segments, and having at least two elevator car control units, each of which is assigned to one of the elevator cars, the method comprising:
executing mutual communication between the shaft control units via a first communication link, and
executing communication between the elevator car control units which are assigned to the elevator cars which are situated in a respective shaft segment and the shaft control unit which is assigned to the respective shaft segment respectively via a second communication link.

30. The method of claim 29 wherein, via the second communication links in each case, direct communication is executed between each of the elevator car control units assigned to the elevator cars which are situated in the respective shaft segment and the shaft control unit which is assigned to the respective shaft segment.

31. The method of claim 29 wherein, via the second communication links, communication is executed between the elevator car control units of two respectively adjoining elevator cars which are situated in the respective shaft segment.

32. The method of claim 29 wherein the elevator installation comprises at least one exchange unit between two adjoining shaft segments, by means of which elevator cars are interchangeable between said two adjoining shaft segments, and
wherein, upon the change of an elevator car from one of the shaft segments to another of the shaft segments, the elevator car control unit which is assigned to the elevator car is removed from the second communication link in the one shaft segment, and is added to the second communication link in the other shaft segment.

33. The method of claim 29 wherein, in the event of the failure of one of the shaft control units and/or one of the elevator car control units, operation of the shaft segment which is currently assigned to said shaft control unit and/or to said elevator car control unit is suspended, wherein the remaining shaft segments continue to operate.
